(19) United States
(12) Patent Application Publication
(10) Pub. No.: US 2024/0289726 A1
(43) Pub. Date: Aug. 29, 2024

(54) APPARATUS AND A METHOD FOR LOAD TRACKING

(71) Applicant: TruckWise, LLC, Estill, SC (US)

(72) Inventor: Wise Henry Batten, JR., Bluffton, SC (US)

(73) Assignee: TruckWise, LLC, Estill, SC (US)

(21) Appl. No.: 18/114,450

(22) Filed: Feb. 27, 2023

(51) Int. Cl. G06Q 10/0833; G06K 7/14

(52) U.S. Cl. CPC G06Q 10/0833; G06K 7/1408

(57) ABSTRACT

An apparatus and a method for load tracking is disclosed. The apparatus includes at least a processor and a memory communicatively connected to the at least a processor. The memory includes instructions configuring the at least a processor to receive load data from a user, classify the load data into one or more load categories, generate a load task as a function of the one or more load categories and generate a load report as a function of the load categories and the load task, wherein the load report includes a unique identifier.

### FIELD OF THE INVENTION

The present invention generally relates to the field of load tracking. In particular, the present invention is directed to an apparatus and a method for load tracking.

### BACKGROUND

Many industries today regularly need long distance and large weight movers for transportation of products from one location to another. In a non-limiting example, in the logging industry, trucks are needed for transportation of trees from the woods to various timber products mills. Likewise, in a non-limiting example, in the pine straw industry, trucks are used for the transportation of pine needles from the woods to an end user or to a business that sells pine straw bales. An easy-to-use solution that efficiently tracks data for transportation of products is necessary. Existing solutions are not satisfactory.

### SUMMARY OF THE DISCLOSURE

In an aspect, an apparatus for load tracking is disclosed. The apparatus includes at least a processor and a memory communicatively connected to the at least a processor. The memory includes instructions configuring the at least a processor to receive load data from a user, classify the load data into one or more load categories, generate a load task as a function of the one or more load categories and generate a load report as a function of the load categories and the load task, wherein the load report includes a unique identifier.

In another aspect, a method for load tracking is disclosed. The method includes receiving, using at least a processor, load data from a user, classifying, using the at least a processor, the load data into one or more load categories, generating, using the at least a processor, a load task as a function of the one or more load categories and generating, using the at least a processor, a load report as a function of the load categories and the load task, wherein the load report includes a unique identifier.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for load tracking;

FIG. 2 is a block diagram of an exemplary embodiment of a machine-learning module;

FIG. 3 is a block diagram illustrating an exemplary embodiment of a neural network;

FIG. 4 is a block diagram illustrating an exemplary embodiment of a node in a neural network;

FIG. 5 is a schematic diagram illustrating an exemplary embodiment of a fuzzy inferencing system;

FIG. 6 is a flow diagram of an exemplary embodiment of a method for load tracking; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a system and a method for load tracking is disclosed. The system includes at least a processor and a memory communicatively connected to the at least a processor. The memory includes instructions configuring the at least a processor to receive load data from a user, classify the load data into one or more load categories, generate a load task as a function of the one or more load categories and generate a load report as a function of the load categories and the load task, wherein the load report includes a unique identifier.

Aspects of the present disclosure can be used to track data of a load. Aspects of the present disclosure can also be used to allow a user to access data of a load using a unique identifier. Exemplary embodiments illustrating aspects of the present disclosure are described below in the context of several specific examples.

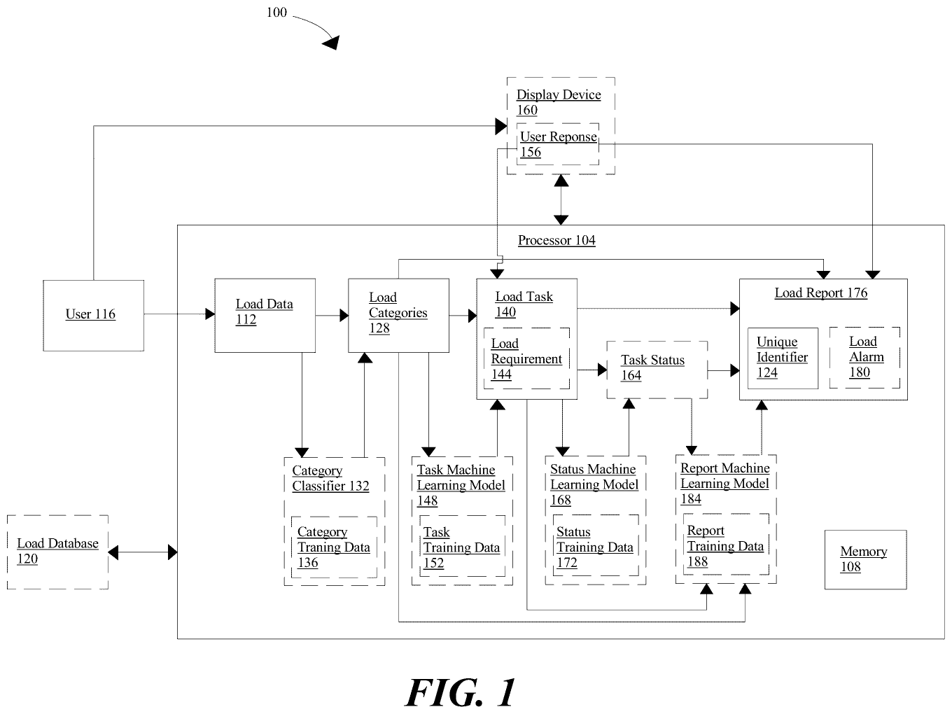

Referring now to FIG. 1, an exemplary embodiment of an apparatus 100 for load tracking is illustrated. Apparatus 100 includes at least a processor 104. The at least a processor 104 may include, without limitation, any processor described in this disclosure. The at least a processor may be included in a computing device. The at least a processor 104 may include any computing device as described in this disclosure, including without limitation a microcontroller, microprocessor, digital signal processor (DSP) and/or system on a chip (SoC) as described in this disclosure. The at least a processor 104 may include, be included in, and/or communicate with a mobile device such as a mobile telephone or smartphone. The at least a processor 104 may include a single computing device operating independently, or may include two or more computing device operating in concert, in parallel, sequentially or the like; two or more computing devices may be included together in a single computing device or in two or more computing devices. The at least a processor 104 may interface or communicate with one or more additional devices as described below in further detail via a network interface device. Network interface device may be utilized for connecting The at least a processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. The at least a processor 104 may include but is not limited to, for example, a computing device or cluster of computing devices in a first location and a second computing device or cluster of computing devices in a second location. The at least a processor 104 may include one or more computing devices dedicated to data storage, security, distribution of traffic for load balancing, and the like. The at least a processor 104 may distribute one or more computing tasks as described below across a plurality of computing devices of computing device, which may operate in parallel, in series, redundantly, or in any other manner used for distribution of tasks or memory between computing devices. The at least a processor 104 may be implemented, as a non-limiting example, using a “shared nothing” architecture.

With continued reference to FIG. 1, at least a processor 104 may be designed and/or configured to perform any method, method step, or sequence of method steps in any embodiment described in this disclosure, in any order and with any degree of repetition. For instance, the at least a processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The at least a processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory 108 communicatively connected to at least a processor 104. The memory 108 includes instructions configuring the at least a processor 104 to receive load data 112 from a user 116. For the purposes of this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, for the purposes of this disclosure, a “user” is any person, group, or company related to a load or a process related to a load. As a non-limiting example, the user 116 may include a service contractor, a loader, a hauler, a mill owner, an employee of a mill, a land owner, a logger, a forester, a driver, a mill operator, and the like. For the purposes of this disclosure, a “load” is amount of things that is being carried or is about to be carried. As a non-limiting example, the load may include a tree, timber, lumber, wood chip, particleboard, furniture, any and the like. As another non-limiting example, the load may include a truckload of trees, lumbers, wood chips, particleboards, furniture, and the like.

With continued reference to FIG. 1, for the purposes of this disclosure, “load data” is data related to a load or a process related to a load. In an embodiment, load data 112 may include transport data. For the purposes of this disclosure, “shipping data” is data related to shipping process of a load. As a non-limiting example, the shipping data may include shipping origin, shipping destination, shipping distance, shipping routes, date of a shipping, loading process, price of shipping, type of transports involved to transport a load, gas used for the transport, address of a destination, address of origin, transport license number, and the like. As a non-limiting example, the transport may include a car, a truck, a watercraft, an aircraft, and the like. In another embodiment, load data 112 may include timber data. For the purposes of this disclosure, “timber data” is data related to a feature of a load, wherein the load includes wood, timber, or products thereof. As a non-limiting example, the timber data may include wood type, wood cut quality, presence of damage, weight, circumference, amount of loads, length of the load, origin of timber, and the like. As another non-limiting example, the timber data may include load process data. For the purposes of this disclosure, “load process data” is data related to any process conducted related to a load. For example, without limitation, the load process data may include seller of the load, purchaser of the load, address of a vendor, address of a mill, address of a company, name of a vendor, name of a mill, name of a hauling company, legal land location, date of milling, date of chopping, the process used to cut the timber, price of a load, timber chopping stages, timber milling process, load selling process, employee involved in any process, and the like. For example, without limitation, the process used to cut the load may include a type of machines used to cut the load, employee, type of gas, environmentally friendly means, and the like. In some embodiments, load data 112 may include load request data. For the purposes of this disclosure, “load request data” is data related to a user's request about a load. As a non-limiting example, may include a user's request for delivery speed, delivery dates, cover requirements for a load while shipping, a type of milling tools, size of transport, a weight of a load, and the like. For the purposes of this disclosure, “cover” is a physical cover that lies on, over, or around a load to protect the load. In some embodiments, the load data 112 may be stored in load database 120. In some embodiments, the load data 112 may be retrieved from the load database 120. The load database 120 disclosed herein is further described below.

With continued reference to FIG. 1, in some embodiments, apparatus 100 may include a load database 120. In some embodiments, the load database 120 may include load data 112, load categories 128, load task 140, task status 164, load report 176, user response 156, and the like. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, in some embodiments, at least a processor 104 may receive load data 112 from a remote device. As a non-limiting example, the remote device may include a mobile telephone, smartphone, tablet, laptop, smartwatch, and the like. In some embodiments, a user 116 may input load data 112 into the remote device by typing on keyboard, typing on a touch screen, touching a touch screen, clicking a mouse, speaking on a microphone, and the like. For example without limitation, a user 116 may input a wood type of a load by typing on a keyboard to a laptop. For example without limitation, a user 116 may input a type of a transport for shipping a load by touching a touch screen of a tablet. In some embodiments, the remote device may include wired or wireless communication. The remote device may use a local area network, a wide area network, the Internet, Bluetooth, or any other network passing electronic wired and/or wireless communication between devices.

With continued reference to FIG. 1, in some embodiments, at least a processor 104 may receive load data 112 from a scanning device. For the purposes of this disclosure, a “scanning device” is a device for scanning a unique identifier. In some embodiments, the scanning device may include an illumination system, a sensor, and a decoder. The sensor in the scanning device may detect the reflected light from the illumination system and may generate an analog signal that is sent to the decoder. The decoder may interpret that signal, validate the unique identifier using the check digit, and convert it into text. This converted text may be delivered by the scanning device to a computing device holding a database of any information of a load. As a non-limiting example, the scanning device may include a pen-type reader, laser scanner, camera-based reader, CCD reader, omni-directional barcode scanner, and the like. For example without limitation, the scanning device may include a mobile device with an inbuild camera such as without limitation, a phone, a tablet, a laptop, and the like. For example without limitation, a user 116 may use a camera on a phone to scan a barcode. In some embodiments, the scanning device may include wired or wireless communication.

With continued reference to FIG. 1, for the purposes of this disclosure, a “unique identifier” is an identifier that is unique for an object among others. As a non-limiting example, the unique identifier 124 may include a universal product code (UPC), a barcode, radio-frequency identification (RFID,) cryptographic hashes, primary key, a unique sequencing of alpha-numeric symbols, QR code, or anything of the like that can be used to identify load data 112. For the purposes of this disclosure, a “barcode” is a code that represents data in a visual, machine-readable form, wherein the code includes a series of bars. In an embodiment, the barcode may include linear barcode. For the purposes of this disclosure, “linear barcode,” also called “one-dimensional barcode” is a barcode that is made up of lines and spaces of various widths or sizes that create specific patterns. In another embodiment, the barcode may include matrix barcode. For the purposes of this disclosure, “matrix barcode,” also called “two-dimensional barcode” is a barcode that is made up of two dimensional ways to represent information. As a non-limiting example, the matrix barcode may include quick response (QR) code, and the like. Unique identifier 124 may take the form of any identifier that uniquely corresponds to the purposes of apparatus 100, this may be accomplished using methods including but not limited to Globally Unique Identifiers (GUIDs), Universally Unique Identifiers (UUIDs), or by maintaining a data structure, table, or database listing all transmitter identifiers and checking the data structure, table listing, or database to ensure that a new identifier is not a duplicate. In an embodiment, the unique identifier 124 may be used to keep track of a load. For example, without limitation, the unique identifier 124 may be used to keep track of prices, stock levels, load information, and the like. In another embodiment, the unique identifier 124 may be used to identify a load from other loads. In another embodiment, the unique identifier 124 may be used to obtain load data 112. In some embodiments, the unique identifier 124 may be used to retrieve the load data 112 from a load database 120. As a non-limiting example, the user 116 may use the unique identifier 124 using a scanning device to retrieve the load data 112 from the load database 112. In some embodiments, the unique identifier 124 may be used as an identification document (ID) for a user 116. For the purposes of this disclosure, an “identification document” is a document used to verify a user's identity. In an embodiment, the unique identifier 124 may include a printed form. As a non-limiting example, the unique identifier 124 may be printed and stuck on a load. As another non-limiting example, the unique identifier 124 may be printed and tagged on a load. As another non-limiting example, a user 116 may have a printed unique identifier 124 on a paper. In another embodiment, the unique identifier 124 may include a digital form. As a non-limiting example, a user 116 may find the unique identifier 124 on a phone screen, tablet, computer screen, or any display device thereof. The unique identifier 124 disclosed herein is further described below.

With continued reference to FIG. 1, memory 108 includes instructions configuring at least a processor 104 to classify load data 112 into one or more load categories 128. For the purposes of this disclosure, a “load category” is a category of associative load data. As a non-limiting example, the one or more load categories 128 may include a load quality category, load measurement category, load quantity category, transport category, load process category, request category, and the like. For the purposes of this disclosure, a “load quality category” is a category of load data that is related to quality of a load. As a non-limiting example, the load quality category may include presence of damage, wood cut quality, type of wood, and the like. For the purposes of this disclosure, a “load quantity category” is a category of load data that is related to quantity of a load. As a non-limiting example, the load quantity category may include number of timbers in the load, number of lumbers in the load, and the like. For the purposes of this disclosure, a “load measurement category” is a category of load data that is related to a measurement of a load. As a non-limiting example, the load measurement category may include a length of a load, a width of a load, weight of a load, and the like. For the purposes of this disclosure, “shipping category” is a category of load data that is related to a transport of a load. As a non-limiting example, the shipping category may include a type of a transport used for shipping, gas used for the transport, shipping cost, shipping route, shipping distance, shipping destination, shipping origin, price of a shipping, and the like. For the purposes of this disclosure, “load process category” is a category of load data that is related to a process conducted related to a load. As a non-limiting example, the load process category may include price of a load, seller of a load, purchaser of a load, a process used to cut a timber, timber chopping stages, timber milling process, load selling process, a machine used to cut the load, a type of gas used in the machine, environmentally friendly means, employee involved in any process, and the like. For the purposes of this disclosure, “request category” is a category of load data that is related to a user request. As a non-limiting example, the request category may include a user's request for delivery speed, delivery dates, cover requirements for a load while shipping, a type of milling tools, size of transport, a weight of a load, and the like.

With continued reference to FIG. 1, in some embodiments, one or more load categories 128 may include an essential data category and/or an inessential data category. For the purposes of this disclosure, “essential data category” is a set of associative load data that is essential. As a non-limiting example, the essential data category may include any load data 112 that is chosen to be essential. For the purposes of this disclosure, “inessential data category” is a set of associative load data that is not essential. As a non-limiting example, the inessential data category may include any load data 112 that is chosen to be inessential data and/or not chosen to be essential data. In some embodiments, a user 116 may choose which load data 112 is essential and/or inessential. Then, at least a processor 104 may receive essential data from the user 116. For the purposes of this disclosure, “essential data” is data that a user chooses from load data to be essential. As a non-limiting example, a user 116 may choose a price of a shipping is essential. As another non-limiting example, a user 116 may choose a wood cut quality is inessential. In some embodiments, the essential data may be classified to essential data category or inessential data category. In some embodiments, the at least a processor 104 may retrieve which load data 112 was essential and/or inessential from a load database 120.

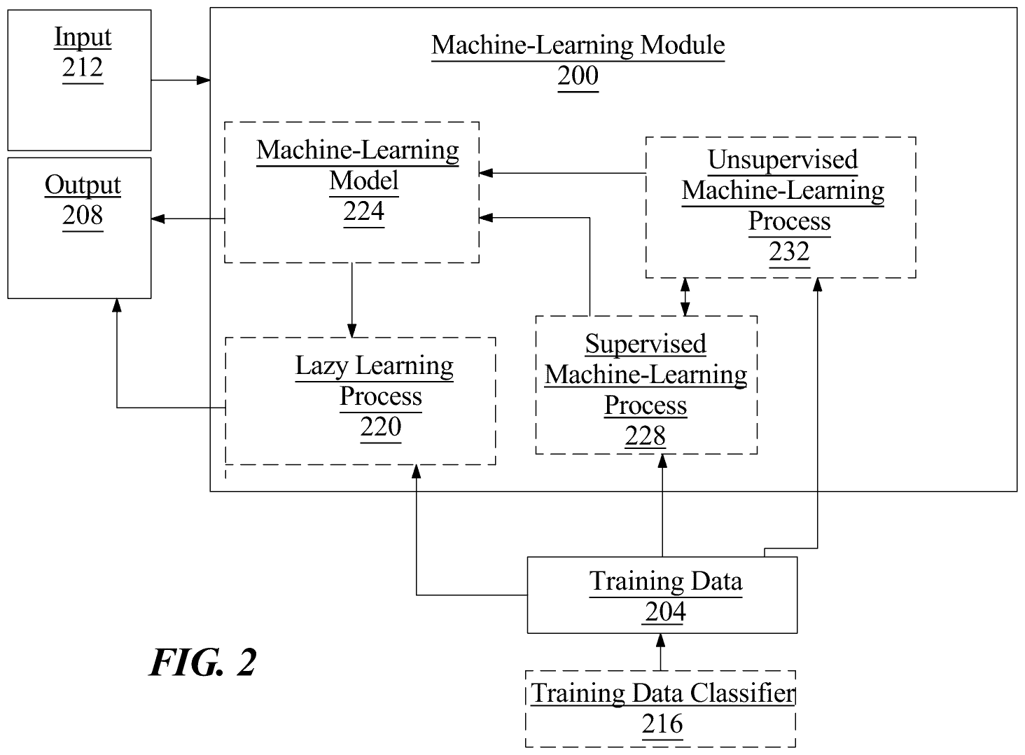

With continued reference to FIG. 1, in some embodiments, at least a processor 104 may classify load data 112 into one or more load categories 128 using a category classifier 132. For the purposes of this disclosure, a “category classifier” is a machine-learning model, such as a mathematical model, neural net, or program generated by a machine learning algorithm known as a “classification algorithm,” that sorts load data related inputs into categories or bins of data, outputting one or more load categories associated therewith. The category classifier 132 disclosed herein may be consistent with a classifier disclosed with respect to FIG. 2. In some embodiments, a category classifier 132 may be trained with category training data 136 correlating load data 112 to one or more load categories 128. For the purposes of this disclosure, “training data” is data containing correlations that a machine-learning process may use to model relationships between two or more categories of data elements. The category training data 136 disclosed herein is further disclosed with respect to FIG. 2. As a non-limiting example, the category classifier 132 may be trained with the category training data 136 that correlates shipping data of load data 112 to a shipping category of one or more load categories 128. As another non-limiting example, the category classifier 132 may be trained with the category training data 136 that correlates timber data of load data 112 to a load quality category of one or more load categories 128. For example without limitation, the category classifier 132 may be trained with the category training data 136 that correlates presence of damage to a load quality category. As another non-limiting example, the category classifier 132 may be trained with the category training data 136 that correlates timber data of load data 112 to a load quantity category of one or more load categories 128. For example without limitation, the category classifier 132 may be trained with the category training data 136 that correlates a number of timbers to a load quantity category. As another non-limiting example, the category classifier 132 may be trained with the category training data 136 that correlates timber data of load data 112 to a load measurement category of one or more load categories 128. For example without limitation, the category classifier 132 may be trained with the category training data 136 that correlates weight of lumbers to a load measurement category. As another non-limiting example, the category classifier 132 may be trained with the category training data 136 that correlates timber data of load data 112 to a load process category of one or more load categories 128. For example without limitation, the category classifier 132 may be trained with the category training data 136 that correlates load process data to a load process category. As another non-limiting example, the category classifier 132 may be trained with the category training data 136 that correlates load request data of load data 112 to a request category of one or more load categories 128. For example without limitation, the category classifier 132 may be trained with the category training data 136 that correlates cover requirements for a load while shipping to a request category. In some embodiments, the category training data 136 may be stored in load database 120. In some embodiments, the category training data 136 may be received from a user 116, load database 120, external computing devices, and/or previous iterations of processing.

With continued reference to FIG. 1, in some embodiments, at least a processor 104 may classify load data 112 to one or more load categories 128 using a category lookup table. A “lookup table,” for the purposes of this disclosure, is an array of data that maps input values to output values. The lookup table may be used to replace a runtime computation with an array indexing operation. As a non-limiting example, an input value of the category lookup table may include a plurality of load data 112. As a non-limiting example, an output value of the category lookup table may include one or more load categories 128. As a non-limiting example, the at least a processor 104 may ‘lookup’ a given shipping data of load data 112 to find a corresponding one or more load categories 128 such as without limitation a shipping category using a category lookup table. As another non-limiting example, the at least a processor 104 may ‘lookup’ a given timber data of load data 112 to find a corresponding one or more load categories 128 such as without limitation a load quality category using a category lookup table. For example without limitation, the category lookup table may correlate presence of damage to a load quality category. As another non-limiting example, the at least a processor 104 may ‘lookup’ a given timber data of load data 112 to a load quantity category of one or more load categories 128 using a category lookup table. For example without limitation, the category lookup table may correlate a number of timbers to a load quantity category. As another non-limiting example, the at least a processor 104 may ‘lookup’ a given timber data of load data 112 to a load measurement category of one or more load categories 128 using a category lookup table. For example without limitation, the category lookup table may correlate weight of lumbers to a load measurement category. As another non-limiting example, the at least a processor 104 may ‘lookup’ a given timber data of load data 112 to a load process category of one or more load categories 128 using a category lookup table. For example without limitation, the category lookup table may correlate load process data to a load process category. As another non-limiting example, the at least a processor 104 may ‘lookup’ a given load request data of load data 112 to a request category of one or more load categories 128 using a category lookup table. For example without limitation, the category lookup table may correlate cover requirements for a load while shipping to a request category. In an embodiment, the lookup table may include interpolation. For the purposes of this disclosure, an “interpolation” refers to a process for estimating values that lie between the range of known data. As a non-limiting example, the lookup table may include an output value for each of input values. When the lookup table does not define the input values, then the lookup table may estimate the output values based on the nearby table values. In another embodiment, the lookup table may include an extrapolation. For the purposes of this disclosure, an “extrapolation” refers to a process for estimating values that lie beyond the range of known data. As a non-limiting example, the lookup table may linearly extrapolate the nearest data to estimate an output value for an input beyond the data.

With continued reference to FIG. 1, memory 108 includes instructions configuring at least a processor 104 to generate a load task 140 as a function of one or more load categories 128. For the purposes of this disclosure, a “load task” is a task related to any process conducted related to a load. In an embodiment, the at least a processor 104 may be configured to generate the load task 140 when load data 112 in the one or more load categories 128 is missing in an essential data category. As a non-limiting example, the load task 140 may include ‘price of a load is missing,’ ‘weight of a load is missing,’ ‘shipping destination is missing,’ ‘enter a measurement of a load,’ ‘enter a type of transport,’ ‘enter a quantity of a load,’ and the like. In another embodiment, the at least a processor 104 may be configured to generate the load task 140 to let a user 116 know what to do as a next step. As a non-limiting example, when the essential data category is filled, the at least a processor 104 may generate the load task 140 to let a user 116 know what to do as a next step. For example without limitation, the load task 140 may include ‘input data,’ ‘start shipping to a destination,’ ‘start milling,’ ‘check a barcode,’ ‘check in with an employee,’ ‘contact an employee,’ ‘check a requirement,’ ‘load to a transport,’ ‘unload from a transport,’ ‘check payment,’ ‘check price of a load,’ and the like. In some embodiments, the load task 140 may include shipping task, load process task, and the like. For the purposes of this disclosure, “shipping task” is a task for a user related to shipping a load. As a non-limiting example, the shipping task may include a process of a shipping, ‘load into a transport,’ ‘unload from a transport,’ ‘start shipping,’ ‘complete shipping,’ ‘enter price of a shipping,’ ‘check weight of a load while shipping,’ ‘check damage of a load while shipping,’ and the like. For the purposes of this disclosure, “load process task” is a task for a user related to shipping a load. As a non-limiting example, the load process task may include a process of milling, a load pricing task, ‘upload a price of a load,’ ‘check a seller,’ ‘check a milling process,’ ‘check a quality of a wood while cutting a tree,’ ‘check a price of a load,’ and the like. Persons skilled in the art, upon reviewing the entirety of this disclosure, would appreciate, after having read the entirety of this disclosure, that various load tasks 140 can be generated as a function of any load categories 128. In some embodiments, the load task 140 may be stored in load database 120. In some embodiments, the load task 140 may be retrieved from the load database 120. Additional disclosure related to a task and/or an action a user has to do may be found in U.S. patent application Ser. No. 18/087,316, filed on Dec. 22, 2022, and entitled “AN APPARATUS AND METHOD FOR COMPLETING ENTITY ACTIONS USING A COMPUTING DEVICE,’ the entirety of which is incorporated as a reference.

With continued reference to FIG. 1, in some embodiments, load task 140 may include a load requirement 144. For the purposes of this disclosure, a “load requirement” is a requirement for a load. As a non-limiting example, the load requirement 144 may include load quality requirement, load quantity requirement, load measurement requirement, load process requirement, shipping requirement, and the like. For the purposes of this disclosure, a “load quality requirement” is a requirement for a quality of a load. As a non-limiting example, the load quality requirement may include a required level of wood cut quality, a required level of damage of a load, and the like. For the purposes of this disclosure, a “load quantity requirement” is a requirement for a quantity of a load. As a non-limiting example, the load quantity requirement may include a required number of timbers, a required number of lumbers, a required number of furniture, a required number of particleboards, and the like. For the purposes of this disclosure, a “load measurement requirement” is a requirement for a quality of a load. As a non-limiting example, the load measurement requirement may include a required length of a load, a required width of a load, a required circumference of a load, a required weight of a load, and the like. For the purposes of this disclosure, a “load process requirement” is a requirement for a quality of a load. As a non-limiting example, the load process requirement may include a required process to cut a tree, a required milling process, a required chopping process, a required selling process, a required machine, a load price requirement, and the like. For the purposes of this disclosure, a “shipping requirement” is a requirement for a quality of a load. As a non-limiting example, the shipping requirement may include a required delivery speed, required delivery date, cover requirements for a load while shipping, required size of a transport, and the like. In some embodiments, a user 116 may input the load requirement 144 into at least a processor 104. In some embodiments, the load requirement 144 may be stored in load database 120. In some embodiments, the load requirement 144 may be retrieved from the load database 120.

With continued reference to FIG. 1, in some embodiments, at least a processor 104 may generate a load requirement 144 as a function of one or more load categories 128. As a non-limiting example, the at least a processor 104 may generate a shipping requirement as a function of a load quality category. For example without limitation, the at least a processor 104 may generate a cover requirement to cover a load when a load quality is high. For example without limitation, the at least a processor 104 may not generate a cover requirement when a load quality is low. As another non-limiting example, the at least a processor 104 may generate a shipping requirement as a function of a load measurement category. For example without limitation, the at least a processor 104 may generate a requirement for a size of a transport as a function of a weight of a load. As a non-limiting example, the at least a processor 104 may generate a load processing requirement as a function of a load quality category. For example without limitation, the at least a processor 104 may generate a requirement for a milling process as a function of a type of wood. Persons skilled in the art, upon reviewing the entirety of this disclosure, would appreciate, after having read the entirety of this disclosure, that various load requirements 144 can be generated as a function of any load categories 128.

With continued reference to FIG. 1, in some embodiments, at least a processor 104 may generate a load requirement 144 as a function of a request category of the one or more load categories 128. As a non-limiting example, when the at least a processor 104 receives a user request from a user 116, the at least a processor 104 may generate a load requirement 144. For example without limitation, the at least a processor 104 may receive the user request from the user 116 to cover a load while shipping, then the at least a processor 104 may generate a load process requirement for the cover requirement. For example, without limitation, the at least a processor 104 may receive the user request from the user 116 to deliver a load within two days, then the at least a processor 104 may generate a shipping requirement for a required delivery speed.

With continued reference to FIG. 1, in some embodiments, at least a processor 104 may generate a load task 140 using a task machine learning model 148. In some embodiments, the task machine learning model 148 may be trained with task training data 152 correlating one or more load categories 128 to a load task 140. As a non-limiting example, the task training data 152 may correlate an essential data category to a load task 140. For example without limitation, the task training data 152 may correlate missing load data 112 in the essential data category to input missing load data 112 of a load task 140. For example without limitation, the task training data 152 may correlate filled essential data category to ‘start shipping’ of a load task 140. In some embodiments, the task machine learning model 148 may be trained with task training data 152 correlating one or more load categories 128 to a load requirement 144. As a non-limiting example, the task training data 152 may correlate a request category to a load requirement 144. For example without limitation, the task training data 152 may correlate ‘cover a load while shipping’ in the request category to a cover requirement of a load requirement 144. As another non-limiting example, the task training data 152 may correlate a load quality category to a shipping requirement. For example without limitation, the task training data 152 may correlate high load quality to a cover requirement to cover a load. As another non-limiting example, the task training data 152 may correlate a load measurement category to a shipping requirement. For example without limitation, the task training data 152 may correlate a weight of a load to a requirement for a size of a transport. As another non-limiting example, the task training data 152 may correlate a load quality category to a load processing requirement. For example without limitation, the task training data 152 may correlate a type of wood to a requirement for a milling process. In some embodiments, the task training data 152 may be received from load database 120, external computing devices, previous iterations of processing, and/or the like.

With continued reference to FIG. 1, in some embodiments, at least a processor 104 may generate a load task 140 using a task lookup table. For the purposes of this disclosure, “task lookup table” is a lookup table that generates a load task. The task lookup table disclosed herein may be consistent with any lookup table disclosed in the entirety of this disclosure. As a non-limiting example, an input value of the task lookup table may include one or more load categories 128. As a non-limiting example, an output value of the category lookup table may include a load task 140. As a non-limiting example, the at least a processor 104 may ‘lookup’ a given essential data category to a load task 140. For example without limitation, the task lookup table may correlate missing load data 112 in the essential data category to ‘input missing load data 112’ of a load task 140. For example without limitation, the task lookup table may correlate filled essential data category to ‘start shipping’ of a load task 140. In some embodiments, the task lookup table may correlate one or more load categories 128 to a load requirement 144. As a non-limiting example, the task lookup table may correlate a request category to a load requirement 144. For example without limitation, the task lookup table may correlate ‘cover a load while shipping’ in the request category to a cover requirement of a load requirement 144. As another non-limiting example, the task lookup table may correlate a load quality category to a shipping requirement. For example without limitation, the task lookup table may correlate high load quality to a cover requirement to cover a load. As another non-limiting example, the task lookup table may correlate a load measurement category to a shipping requirement. For example without limitation, the task lookup table may correlate a weight of a load to a requirement for a size of a transport. As another non-limiting example, the task lookup table may correlate a load quality category to a load processing requirement. For example without limitation, the task lookup table may correlate a type of wood to a requirement for a milling process.

With continued reference to FIG. 1, in some embodiments, at least a processor 104 may receive a user response 156. For the purposes of this disclosure, a “user response” is any response input from a user. As a non-limiting example, the user response may include a task response, requirement response, report response, and the like. The report response disclosed herein is further described below. In some embodiments, a user 116 may input user response 156 using a display device 160. In some embodiments, the user 116 may input the user response 156 using a user interface. As a non-limiting example, the user 116 may touch a touch screen to click an icon on a screen to input the user response 156. As another non-limiting example, the user 116 may input user response 156 by clicking an image on a screen of a phone. As another non-limiting example, the user 116 may type on a keyboard to input user response 156. For the purposes of this disclosure, a “task response” is a response from a user related to a load task. As a non-limiting example, the task response may include confirming a load task 140, inputting a missing load data 112, completing a load task 140, rejecting a load task 140, and the like. For the purposes of this disclosure, a “requirement response” is a response from a user that is related to a load requirement. As a non-limiting example, the requirement response may include confirming a load requirement 144, accepting a load requirement 144, rejecting a load requirement 144, and the like. In some embodiments, the at least a processor 104 may receive the user response 156 from a remote device, a display device 160, and/or the like. In some embodiments, a user 116 may input the user response 156 by typing, clicking, touching, speaking, and the like on the remote device, display device 160, and/or the like. Persons skilled in the art, upon reviewing the entirety of this disclosure, would appreciate, after having read the entirety of this disclosure, various ways that may be used to input the user response 156.

With continued reference to FIG. 1, in some embodiments, at least a processor 104 may determine a task status 164 of a load task 140. As used in this disclosure, an “task status” is a status of a load task. As a non-limiting example, the task status 164 may include ‘complete,’ ‘reject,’ ‘incomplete,’ ‘active,’ and the like. In some embodiments, the at least a processor 104 may determine the task status as a function of a user response 156. As a non-limiting example, a task status 164 of a load task 140 may be ‘complete,’ when a user 116 input load data 112 for a missing load data 112 in an essential data category. As another non-limiting example, a task status 164 of a load task 140 may be ‘complete,’ when a user 116 completes the load task 140 and input a user response 156 that the load task 140 is completed. As another non-limiting example, a task status of a load task 140 may be ‘incomplete,’ when the load task 140 is not checked by a user 116. As another non-limiting example, a task status of a load task 140 may be ‘incomplete,’ when any user response 156 is received by a user 116. As another non-limiting example, a task status of a load task 140 may be ‘active,’ when a user 116 confirms the load task 140. As another non-limiting example, a task status of a load task 140 may be ‘reject’ when a user 116 rejects the load task 140. Additional disclosure related to determining a completion of a task may be found in U.S. patent application Ser. No. 18/087,316, filed on Dec. 22, 2022, and entitled “AN APPARATUS AND METHOD FOR COMPLETING ENTITY ACTIONS USING A COMPUTING DEVICE,’ the entirety of which is incorporated as a reference.

With continued reference to FIG. 1, in some embodiments, a task status 164 may include a completion status of a load requirement 144. For the purposes of this disclosure, a “completion status” is a status that indicates whether a task requirement has been completed or not. As a non-limiting example, a task status 164 of a load requirement 144 may be ‘complete’ when a user 116 completes the load requirement 144 and input a user response 156 that the load requirement 144 is completed. As another non-limiting example, a task status 164 of a load requirement 144 may be ‘incomplete’ when the load requirement 144 is not checked by a user 116. As another non-limiting example, a task status 164 of a load requirement 144 may be ‘incomplete’ when any user response 156 is received by a user 116. As another non-limiting example, a task status of a load requirement 144 may be ‘active’ when a user 116 confirms the load requirement 144. As another non-limiting example, a task status of a load requirement 144 may be ‘reject’ when a user 116 rejects the load requirement 144.

With continued reference to FIG. 1, in some embodiments, at least a processor 104 may generate a task status 164 using a status machine learning model 168. For the purposes of this disclosure, a “status machine learning model” is a machine learning model that determines a status of a load task 140. In some embodiments, the status machine learning model 168 may be trained with status training data 172 correlating a user response 156 to a task status 164 of a load task 140. As a non-limiting example, the status machine learning model 168 may be trained with the status training data 172 that correlates confirming a load task 140 of a user response 156 to ‘active’ of a task status 164. As another non-limiting example, the status training data 172 may correlate inputting a missing load data 112′ of a user response 156 to ‘complete’ of a task status 164. As another non-limiting example, the status training data 172 may correlate completing a load task 140 of a user response 156 to ‘complete’ of a task status 164. As another non-limiting example, the status training data 172 may correlate rejecting a load task 140 of a user response 156 to ‘reject’ of a task status 164. In some embodiments, the status machine learning model 168 may be trained with status training data 172 correlating a user response 156 to a task status 164 of a load requirement 144. As a non-limiting example, the status machine learning model 168 may be trained with the status training data 172 that correlates confirming a load requirement 144 of a user response 156 to ‘active’ of a task status 164 of the load requirement 144. As another non-limiting example, the status training data 172 may correlate completing a load requirement 144 of a user response 156 to ‘complete’ of a task status 164 of the load requirement 144. As another non-limiting example, the status training data 172 may correlate rejecting a load requirement 144 of a user response 156 to ‘reject’ of a task status 164 of the load requirement 144. In some embodiments, the at least a processor 104 may receive the status training data 172 from load database 120, external computing devices, and/or previous iterations of processing.

With continued reference to FIG. 1, in some embodiments, at least a processor 104 may generate a load task 140 by generating, using a task machine learning model 148, a first load task, wherein the task machine learning model 148 may be trained with task training data 152 that correlates one or more load categories 128 to a load task 140, receiving, using the at least a processor 104, a user response 156 from a user 116 for the first load task, identifying, using the at least a processor 104, a task status 164 of the first load task 140, and generating, using the task machine learning model 148, a second load task when the task status 164 of the first load task is ‘complete.’ In some embodiments, the task machine learning model 148 may generate the second load task when the task status 164 of the first load task 140 is ‘reject.’ In some embodiments, the at least a processor 104 may generate a load task 140 by generating, using a task lookup table, the first load task, wherein the task lookup table may correlate one or more load categories 128 to the first load task. The at least a processor 104, then, may receive the user response 156 from the user 116 for the first load task, identify the task status 164 of the first load task 140 and generate, using the task lookup table, the second load task when the task status 164 of the first load task is ‘complete.’

With continued reference to FIG. 1, at least a processor 104 is configured to generate a load report 176. For the purposes of this disclosure, “load report” is a report for a user related to a load. In some embodiments, the load report 176 may include a form of a text, an audio, an image, a graph, a table, a video, and the like. In an embodiment, the load report 176 may be read-only. In another embodiment, the load report 176 may be writable. In some embodiments, the writable load report may require authentication; for instance without limitation, the writable load report may be writable only given a unique identifier 124 indicating that the device that will be modifying the load report 176 is authorized. In some embodiments, the load report 176 may include any combination of the above; for instance without limitation, the load report 176 may include a read-only section. For example without limitation, the load report 176 may include a writable section with limited access. For the purposes of this disclosure, “writable section” is a section of a load report that is writable. In some embodiments, the load report 176 may include a writable section with general access, to which any user may be able to input data. The load report 176 may include the read-only section and the generally writable section, or the limited access writable section and the generally writable section, or the read-only section and the limited access section. The limited access section may be limited to users 116 of the apparatus 100, or in other words may be generally writable, but only to users of the apparatus 100, who may have the unique identifier 124; the users may alternatively be granted the unique identifier 124 by the apparatus 100 to update data only when authorized by the apparatus 100, and otherwise be unable to update the load report 176. In some embodiments, a unique identifier 124 may allow an access to a particular portion of a load report 176. As a non-limiting example, a first unique identifier 124 may allow an access to only a load process portion of a load report 176 while a second unique identifier 124 may allow an access to only a shipping portion of the load report 176. Then, a user 116 with the first unique identifier 124 may be able to view and/or modify the load process portion of the load report 176 while a user 116 with the second unique identifier 124 may be able to view and/or modify the shipping portion of the load report 176 but not any other portion of the load report 176 including the load process portion of the load report 176. In some embodiments, preventing users from being able to write over a load report 176 enables the load report 176 to be free from intentional or unintentional corruption or inaccuracy, and enables the apparatus 100 to ensure that certain information is always available to users 116. In some embodiments, writable sections enable the apparatus 100 itself or users of the apparatus 100 to correct, augment, or update information as described in further detail below. In some embodiments, the load report 176 may be stored in load database 120. In some embodiments, the load report 176 may be retrieved from the load database 120.

With continued reference to FIG. 1, in some embodiments, at least a processor 104 is configured to generate the load report 176 as a function of one or more load categories 128. In an embodiment, the at least a processor 104 may generate a load quality report for a load quality category. For the purposes of this disclosure, a “load quality report” is a report related to a quality of a load. As a non-limiting example, the load quality report may include a report of presence of damage, wood cut quality type of wood, and the like. In another embodiment, the at least a processor 104 may generate a load quantity report for a load quantity category. For the purposes of this disclosure, a “load quantity report” is a report for a user related to a quantity of a load. As a non-limiting example, the load quantity report may include a list of number of timbers in the load, a table of number of lumbers in the load, and the like. In another embodiment, the at least a processor 104 may generate a load measurement report for a load measurement category. For the purposes of this disclosure, a “load measurement category” is a report for a user related to a load. As a non-limiting example, the load measurement report may include a table of a length of a load, a width of a load, weight of a load, and the like. In another embodiment, the at least a processor 104 may generate a shipping report for a shipping category. For the purposes of this disclosure, “shipping report” is a report for a user related to a load. As a non-limiting example, the shipping report may include a text form of a type of a transport used for shipping, a text form of gas used for the transport, a table of shipping cost, an animation of shipping route, a text form of shipping distance, an image of shipping destination, an image of shipping origin, a text form of an address of shipping destination, a table of price of a shipping, and the like. As another non-limiting example, the shipping report may include a map, a navigation, and the like. In another embodiment, the at least a processor 104 may generate a load process report for a load process category. For the purposes of this disclosure, “load process report” is a report for a user related to a load. As a non-limiting example, the load process report may include a table of price of a load, a text form of a seller of a load, a list of purchaser of a load, a table of a process used to cut a timber, a video of timber chopping stages, an animation of timber milling process, a table of a load selling process, an image of a machine used to cut the load, a text form of a type of gas used in the machine, a list of environmentally friendly means, a table of employee involved in any process, and the like.

With continued reference to FIG. 1, in some embodiments, at least a processor 104 is configured to generate a load report 176 as a function of a load task 140. As a non-limiting example, the at least a processor 104 may generate a task report for the load task 140. For the purposes of this disclosure, a “task report” is a report for a user related to a load task. As a non-limiting example, the task report may include a list of load tasks 140. For example without limitation, the task report may include a list of missing load data 112 in an essential data category, a table of milling process, an animation of shipping routes, and the like. In some embodiments, the task report may include a requirement report. For the purposes of this disclosure, a “requirement report” is a report for a user related to a load requirement. As a non-limiting example, the requirement report may include a list of a load requirement 144, an image representation of a load requirement, and the like. In some embodiments, the task report may include a status report. For the purposes of this disclosure, a “status report” is a report related to a status of a load task. As a non-limiting example, the status report may include a list of status of load tasks 140, a table of status of load tasks 140, a list of completed load tasks, a list of incomplete load tasks, a list of active load tasks, and the like.

With continued reference to FIG. 1, in some embodiments, at least a processor 104 may be configured to generate a load report 176 as a function of a user response 156. As a non-limiting example, the at least a processor 104 may generate a user activity report as a function of the user response 156. For the purposes of this disclosure, “user activity report” is a report for a user related to any activity of a user. As a non-limiting example, the user activity report may include a report of a user's request about a load, a list of user responses 156, and the like.

With continued reference to FIG. 1, in some embodiments, a load report 176 may include a unique identifier 124. The unique identifier 124 disclosed herein is further described above. In some embodiments, a user 116 may use the unique identifier 124 for various purposes. As a non-limiting example, the user 116 may use the unique identifier 124 such as without limitation a barcode, to check in into the mill. As another non-limiting example, the user 116 may use the unique identifier 124 to get an access to load data 112. As another non-limiting example, the user 116 may use the unique identifier to get an access to load task 140. As another non-limiting example, the user 116 may use the unique identifier to update load data 112. As another non-limiting example, the user 116 may use the unique identifier 124 to modify load data 112.

With continued reference to FIG. 1, in some embodiments, a load report 176 may include a load alarm 180. For the purposes of this disclosure, a “load alarm” is an indication for alerting a user about a load. In some embodiments, the load alarm 180 may include a text, an audio, an image, a video, and the like. In an embodiment, the load alarm 180 may ask a user 116 for a user response 156. In an embodiment, the load alarm 180 may alert a user 116 for a load task 140. In another embodiment, the load alarm 180 may alert a user 116 for a load requirement 144. As a non-limiting example, the load alarm 180 may include ‘input load data,’ ‘check a load task,’ ‘check a load requirement,’ ‘you are missing a load task,’ ‘you are failing a load task,’ ‘check a load report,’ ‘check a barcode,’ and the like.

With continued reference to FIG. 1, in some embodiments, at least a processor 104 may be configured to receive a user response 156 for a load report 176. As a non-limiting example, the at least a processor 104 may receive a report response from a user 116. For the purposes of this disclosure, a “report response” is a response from a user related to a load report. As a non-limiting example, the report response may include a user response 156 for a load alarm 180. For example, without limitation, the report response may include clicking, touching the load alarm 180. By inputting the report response, it may direct a user 116 to a content of the load alarm 180. As a non-limiting example, when a user 116 clicks a load alarm 180 that may include ‘input load data,’ the user 116 may be directed to a section of an apparatus 100 that allow a user 116 to input load data 112.

With continued reference to FIG. 1, in some embodiments, at least a processor 104 may be further configured to update a load report 176. For the purposes of this disclosure, “updating” refers to making a load report up to date. In some embodiments, the at least a processor 104 may modify the load report 176 and update the load report 176 when the at least a processor 104 receives new load data 112. As a non-limiting example, a price of shipping may be added to the load report 176 when the load report 176 only had a destination of shipping, origin of shipping and shipping route. As another non-limiting example, a price of shipping may be modified from $400 to $600. As another non-limiting example, a price of shipping may be removed from the load report 175. In some embodiments, the at least a processor 104 may modify the load report 176 and update the load report 176 as a function of the user response 156. As a non-limiting example, the at least a processor may modify a list of load requirements of the load report 176 when a user 116 input ‘reject a load requirement’ for a user response 156. Persons skilled in the art, upon reviewing the entirety of this disclosure, would appreciate, after having read the entirety of this disclosure, that various modifications of load report 176 can be made other than the non-limiting examples disclosed herein.

With continued reference to FIG. 1, in some embodiments, at least a processor 104 may be configured to generate a load report 176 using a report machine learning model 184. In some embodiments, the report machine learning model 184 may be trained with report training data 188. As a non-limiting example, the report training data 188 may correlate one or more load categories 128 to a load report 176. For example without limitation, the report training data 188 may correlate a shipping category to a shipping report. For example without limitation, the report training data 188 may correlate a price of a load to a load process report. As another non-limiting example, the report training data 188 may correlate a load task 140 to a load report 176. For example without limitation, the report training data 188 may correlate a completion status of a load requirement 144 to a status report. For example without limitation, the report training data 188 may correlate a load task 140 to a task report, wherein the task report may include a list of missing load data in an essential category. As another non-limiting example, the report training data 188 may correlate a user response 156 to a load report 176. For example without limitation, the report training data 188 may correlate a user response 156 to a user activity report of a list of user responses 156. In some embodiments, the report training data 188 may be stored in a load database 120. In some embodiments, the report training data 188 may be retrieved from a load database 120, external computing devices, and/or previous iterations of processing.

With continued reference to FIG. 1, in some embodiments, an apparatus 100 may include a display device. For the purposes of this disclosure, a “display device” is a device that visually displays information. As a non-limiting example, display device 160 may include, but is not limited to, smartphones, tablets, laptops, touch screens, monitors, headsets, glasses, smartwatches, and the like. In some embodiments, at least a processor 104 may be configured to display load data 112, load task 140, load requirement 144, task status 164, load report 176, unique identifier 124, and the like.

With continued reference to FIG. 1, in some embodiments, at least a processor 104 may be configured to generate a user interface. For the purposes of this disclosure, a “user interface” is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof and the like. In some embodiments, user interface may operate on and/or be communicatively connected to a decentralized platform, metaverse, and/or a decentralized exchange platform associated with the user. For example, a user may interact with user interface in virtual reality. In some embodiments, a user may interact with the use interface using a computing device distinct from and communicatively connected to at least a processor 104. For example, a smart phone, smart, tablet, or laptop operated by the user. In an embodiment, user interface may include a graphical user interface. A “graphical user interface,” as used herein, is a graphical form of user interface that allows users to interact with electronic devices. In some embodiments, GUI may include icons, menus, other visual indicators or representations (graphics), audio indicators such as primary notation, and display information and related user controls. A menu may contain a list of choices and may allow users to select one from them. A menu bar may be displayed horizontally across the screen such as pull down menu. When any option is clicked in this menu, then the pull down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application such as without limitation a dialog box for users to customize their computer screen appearances. User interface controls may include software components that a user interacts with through direct manipulation to read or edit information displayed through user interface. Widgets may be used to display lists of similar items, navigate the system using links, tabs, and manipulate data using check boxes, radio boxes, and the like.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, for instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs such as entity actions and outputs such as second entities.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to second entity types, based on, as non-limiting examples, cost, vehicles, timeframe, availability, and the like.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include entity actions as described above as inputs, second entities as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

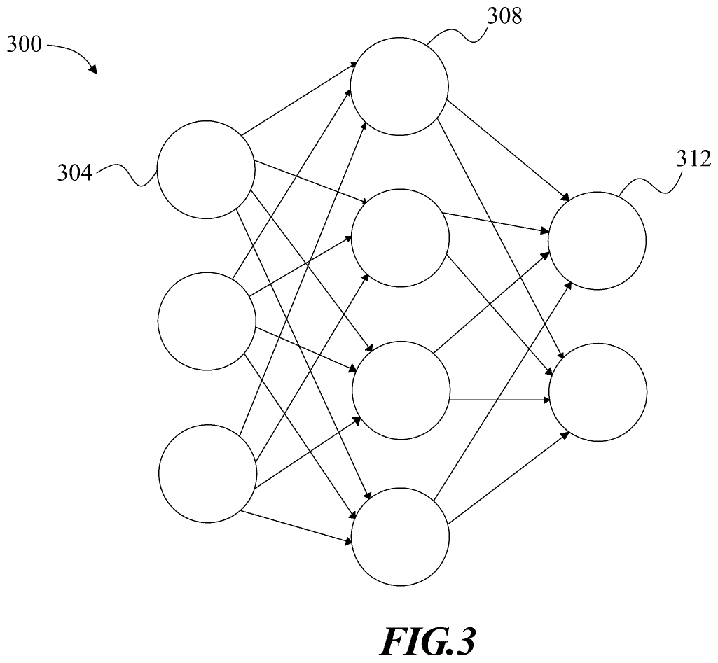

Referring now to FIG. 3, an exemplary embodiment of neural network 300 is illustrated. A neural network 300, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

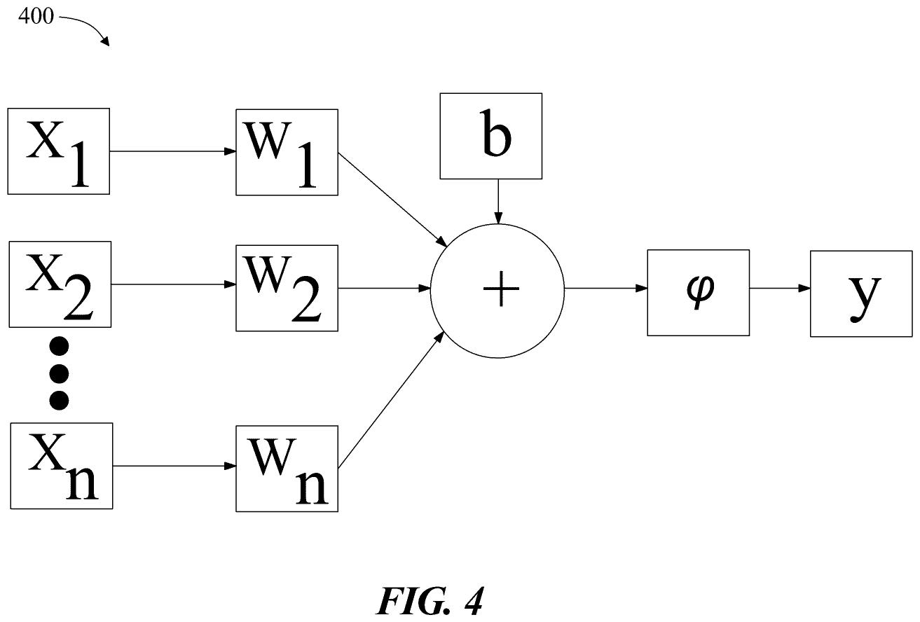

Referring now to FIG. 4, an exemplary embodiment of a node of a neural network is illustrated. A node may include, without limitation, a plurality of inputs x, that may receive numerical values from inputs to a neural network containing the node and/or from other nodes. Node may perform a weighted sum of inputs using weights wᵢ, that are multiplied by respective inputs xi. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight w; applied to an input x, may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

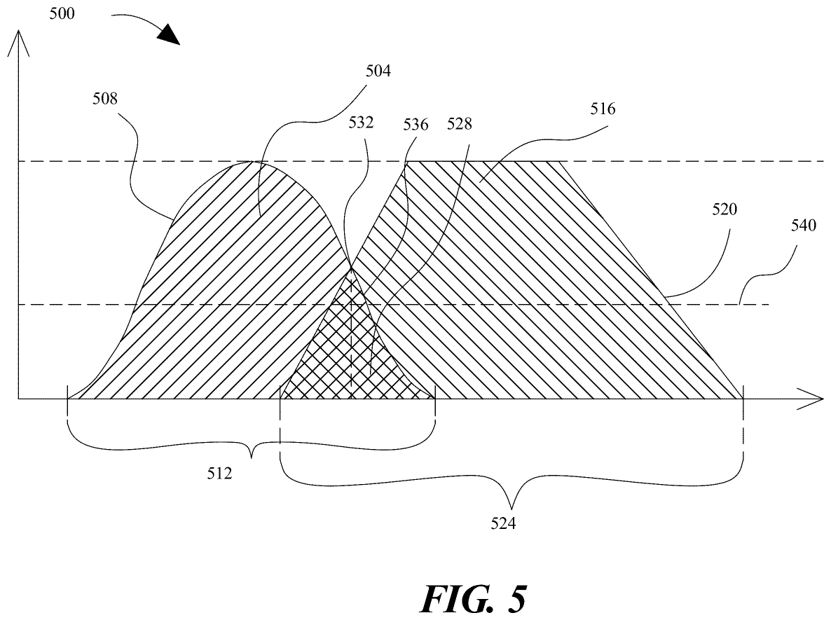

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models and a predetermined class. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively, or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or entity action and a predetermined class, such as without limitation second entity categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify an entity action with second entity. For instance, if a second entity has a fuzzy set matching entity action fuzzy set by having a degree of overlap exceeding a threshold, processor 104 may classify the entity action as belonging to the second entity categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, an entity action may be compared to multiple second entity categorization fuzzy sets. For instance, entity action may be represented by a fuzzy set that is compared to each of the multiple second entity categorization fuzzy sets; and a degree of overlap exceeding a threshold between the entity action fuzzy set and any of the multiple second entity categorization fuzzy sets may cause processor 104 to classify the entity action as belonging to second entity categorization. For instance, in one embodiment there may be two second entity categorization fuzzy sets, representing respectively second entity categorization and a second entity categorization. Initial second entity categorization may have a first fuzzy set; Subsequent second entity categorization may have a second fuzzy set; and entity action may have an entity action fuzzy set. processor 104, for example, may compare a entity action fuzzy set with each of second entity categorization fuzzy set and in second entity categorization fuzzy set, as described above, and classify a entity action to either, both, or neither of second entity categorization nor in second entity categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, entity action may be used indirectly to determine a fuzzy set, as entity action fuzzy set may be derived from outputs of one or more machine-learning models that take the entity action directly or indirectly as inputs.

Still referring to FIG. 5, a computing device may use a logic comparison program, such as, but not limited to, a fuzzy logic model to determine a second entity response. An second entity response may include, but is not limited to, second entity with highest applicant rating, second entity with nearest distance, second entity with highest number of entity action completed, and the like thereof; each such second entity response may be represented as a value for a linguistic variable representing second entity response or in other words a fuzzy set as described above that corresponds to a degree of match of second entity as calculated using any statistical, machine-learning, or other method that may occur to a person skilled in the art upon reviewing the entirety of this disclosure. In other words, a given element of entity action may have a first non-zero value for membership in a first linguistic variable value and a second non-zero value for membership in a second linguistic variable value. In some embodiments, determining a second entity categorization may include using a linear regression model. A linear regression model may include a machine learning model. A linear regression model may be configured to map data of entity action, such as degree of match to one or more second entity parameters. A linear regression model may be trained using a machine learning process. A linear regression model may map statistics such as, but not limited to, quality of entity action. In some embodiments, determining a second entity of entity action may include using a second entity classification model. A second entity classification model may be configured to input collected data and cluster data to a centroid based on, but not limited to, frequency of appearance, linguistic indicators of quality, and the like. Centroids may include scores assigned to them such that quality of entity action may each be assigned a score. In some embodiments, the second entity classification model may include a K-means clustering model. In some embodiments, the second entity classification model may include a particle swarm optimization model. In some embodiments, determining the second entity of an entity action may include using a fuzzy inference engine. A fuzzy inference engine may be configured to map one or more entity action data elements using fuzzy logic. In some embodiments, entity action may be arranged by a logic comparison program into second entity arrangement. A “second entity arrangement” as used in this disclosure is any grouping of objects and/or data based on skill level and/or output score. This step may be implemented as described above in FIGS. 1-4. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to entity action, such as a degree of match of an element, while a second membership function may indicate a degree of in second entity of a subject thereof, or another measurable value pertaining to entity action. Continuing the example, an output linguistic variable may represent, without limitation, a score value. An inference engine may combine rules, such as: “if the rating score of a second entity is ‘high’ and the distance to first entity is ‘close’, the second entity is ‘suitable’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

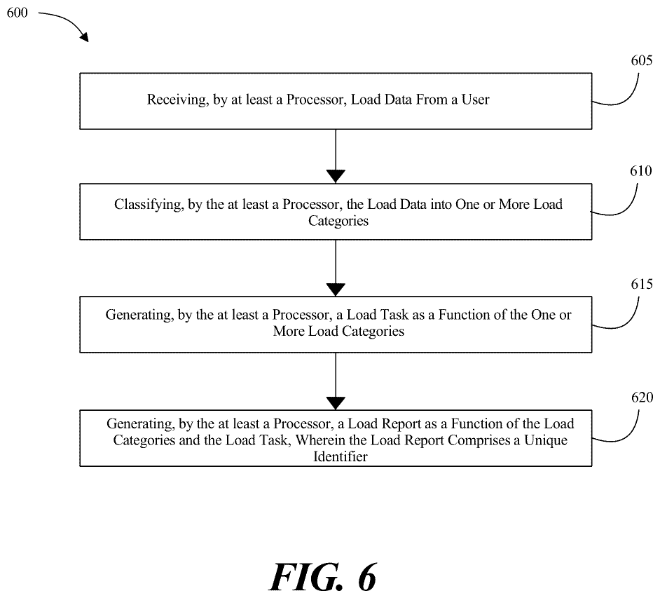

Now referring to FIG. 6, an exemplary method 600 for load tracking is disclosed. The method includes a step 605 of receiving, using at least a processor, load data from a user. In some embodiments, the load data may include timber data, wherein the timber data may include load process data. The method includes a step 610 of classifying, using the at least a processor, the load data into one or more load categories. The method includes a step 615 of generating, using the at least a processor, a load task as a function of the one or more load categories. In some embodiments, the load task may include a load requirement. In some embodiments, generating the load task may include receiving a user response, wherein the user response may include a requirement response. In some embodiments, the one or more load categories may include an essential data category. In some embodiments, the method 600 may further include generating, using the at least a processor, the load task as a function of the essential data category. In some embodiments, the step 615 may further include determining a task status, wherein the task status may include a completion status of the load requirement. In some embodiments, the step 615 may further include generating, using a task machine-learning model, a first load task, wherein the task machine-learning model may be configured to correlate task training data to the load task, receiving, using the at least a processor, a user response from the user for the first load task, identifying, using the at least a processor, a task status and generating, using the task machine-learning model, a second load task as a function of the task status. The method includes a step 620 of generating, using the at least a processor, a load report as a function of the load categories and the load task. In some embodiments, the load report includes a unique identifier. In some embodiments, the load report may further include a writable section with a limited access, wherein the unique identifier may be configured to allow the user to access the writable section of the load report with the limited access. In some embodiments, the method 600 may further include receiving, using the at least a processor, the load data by scanning the unique identifier, wherein the unique identifier may include a barcode. In some embodiments, the method 600 may further include displaying, using the at least a processor, the load report on a display device. This may be implemented, without limitation, as described above in reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

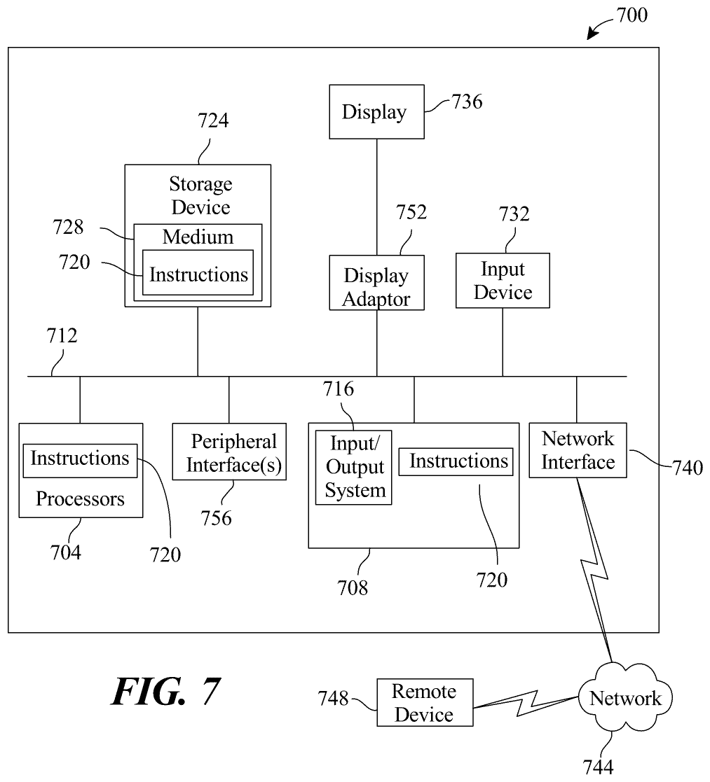

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for load tracking, wherein the apparatus comprises:
at least a processor;
a scanning device communicatively connected to the at least a processor, wherein the scanning device comprises at least an illumination system and a sensor, wherein the scanning device is configured to:
scan a first unique identifier comprising a matrix barcode, wherein scanning the first unique identifier comprises detecting reflected light from the illumination system using the sensor; and
convert the matrix barcode to text data; and
a memory communicatively connected to the at least a processor, the memory containing instructions configuring the at least a processor to:
receive load data from a user;
classify the load data into one or more load categories;
generate a load task as a function of the one or more load categories;
generate a load report as a function of the load categories and the load task wherein the load report comprises:
a limited access writable section, wherein the first unique identifier is configured to allow the user to access the limited access writable section of the load report;
a read-only section; and
wherein generating the load report comprises utilizing an artificial neural network, wherein utilizing the artificial neural network comprises:
generating training data, wherein generating the training data comprises:
retrieving a plurality of load data from a database;
classifying the plurality of load data into an essential category or a nonessential category; and
removing elements of the plurality of load data classified to the nonessential category from the training data;
training the artificial neural network by applying the training data to input nodes of the artificial neural network, wherein the training data comprises historical load tasks correlated to historical load reports, and wherein the training data is used to adjust connections and weights between nodes in adjacent layers of the artificial neural network; and
outputting the load report at output nodes of the artificial neural network;
receive the first unique identifier from the scanning device;
validate the first unique identifier using at least a check digit of the first unique identifier;
allow, as a function of the validated first unique identifier, the user to modify the limited access writable section;
allow, as a function of the validated first unique identifier, the user to access the read-only section; and
prevent the user from modifying the read-only section.

2. (canceled)

3. The apparatus of claim 1, wherein the load data comprises timber data, wherein the timber data comprises load process data.

4. (canceled)

5. The apparatus of claim 1, wherein the load task comprises a load requirement.

6. The apparatus of claim 1, wherein generating the load task comprises receiving a user response, wherein the user response comprises a requirement response.

7. The apparatus of claim 1, wherein generating the load task comprises determining a task status, wherein the task status comprises a completion status of the load requirement.

8. The apparatus of claim 1, wherein generating the load task comprises:
generating, using a task machine-learning model, a first load task, wherein the task machine-learning model is configured to correlate task training data to the load task;
receiving, using the at least a processor, a user response from the user for the first load task;
identifying, using the at least a processor, a task status; and
generating, using the task machine-learning model, a second load task as a function of the task status.

9. (canceled)

10. The apparatus of claim 1, wherein:
the apparatus further comprises a display device; and
the memory contains instructions further configuring the at least a processor to display the load report on the display device.

11. A method for load tracking, wherein the method comprises:
scanning, using a scanning device communicatively connected to at least a processor, a first unique identifier comprising a matrix barcode, wherein:
the scanning device comprises at least an illumination system and a sensor; and
scanning the first unique identifier comprises detecting reflected light from the illumination system using the sensor;
converting, using the scanning device, the matrix barcode to text data;
receiving, using the at least a processor, load data from a user;
classifying, using the at least a processor, the load data into one or more load categories;
generating, using the at least a processor, a load task as a function of the one or more load categories;
generating, using the at least a processor, a load report as a function of the load categories and the load task, wherein the load report comprises:
a limited access writable section, wherein the unique identifier is configured to allow the user to access the limited access writable section of the load report; and
a read-only section; and
wherein generating the load report comprises utilizing an artificial neural network, wherein utilizing the artificial neural network comprises:
generating training data, wherein generating the training data comprises:
retrieving a plurality of load data from a database;
classifying the plurality of load data into an essential category or a nonessential category; and
removing elements of the plurality of load data classified to the nonessential category from the training data;
training the artificial neural network by applying the training data to input nodes of the artificial network, wherein the training data comprises historical load tasks correlated to historical load reports, and wherein the training data is used to adjust connections and weights between nodes in adjacent layers of the artificial neural network; and
outputting the load report at output nodes of the artificial neural network;
receiving, using the at least a processor, the first unique identifier from the scanning device;
validating, using the at least a processor, the first unique identifier using at least a check digit of the first unique identifier;
allowing, using the at least a processor, as a function of the validated first unique identifier, the user to modify the limited access writable section;
allowing, using the at least a processor, as a function of the validated first unique identifier, the user to access the read-only section; and
preventing, using the at least a processor, the user from modifying the read-only section.

12. (canceled)

13. The method of claim 11, wherein the load data comprises timber data, wherein the timber data comprises load process data.

14. (canceled)

15. The method of claim 11, wherein the load task comprises a load requirement.

16. The method of claim 11, wherein generating the load task comprises receiving a user response, wherein the user response comprises a requirement response.

17. The method of claim 11, wherein generating the load task comprises determining a task status, wherein the task status comprises a completion status of the load requirement.

18. The method of claim 11, wherein generating the load task comprises:
generating, using a task machine-learning model, a first load task, wherein the task machine-learning model is configured to correlate task training data to the load task;
receiving, using the at least a processor, a user response from the user for the first load task;
identifying, using the at least a processor, a task status; and
generating, using the task machine-learning model, a second load task as a function of the task status.

19. (canceled)

20. The method of claim 11, further comprising:
displaying, using the at least a processor, the load report on a display device.
